(19) United States
(12) Patent Application Publication
(10) Pub. No.: US 2022/0268185 A1
(43) Pub. Date: Aug. 25, 2022

(54) Sump Fluid Level Regulation Method and System

(71) Applicant: Castrol Limited, Pangbourne, Reading (GB)

(72) Inventors: Ross Alexander Dewhurst, Reading (GB); Oliver Paul Taylor, London (GB)

(21) Appl. No.: 17/631,714

(22) PCT Filed: Jul. 31, 2020
(86) PCT No.: PCT/EP2020/071679

§ 371 Date: Jan. 31, 2022

(30) Foreign Application Priority Data
Aug. 1, 2019 (GB) 1911003.0
Jan. 10, 2020 (GB) 2000375.2

(51) Int. Cl. F01M 11/12; F01M 11/04; F01M 1/02

(52) U.S. Cl. CPC F01M 11/12; F01M 11/0458; F01M 11/0408; F01M 1/02

(57) ABSTRACT

The present disclosure relates to a method and system of maintaining a predetermined working quantity of fluid in a reduced volume sump of a motor or vehicle. The method includes recurrently determining a quantity of fluid in the sump and comparing the determined quantity of fluid to the predetermined working fluid quantity. In response to identifying a deviation between the determined quantity of fluid and the predetermined working fluid quantity, the method includes sending a control signal to a fluid pumping system to transfer fluid between the sump and a fluid container.

### CROSS REFERENCE TO RELATED APPLICATIONS

This application claims priority to GB Patent Application No. 1911003.0, filed Aug. 1, 2019, and GB Patent Application No. 2000375.2, filed Jan. 10, 2020, both of which are hereby incorporated by reference in their entirety.

### BACKGROUND

Many motors and vehicles use one or more fluids for their operation. Such fluids are often liquids. For example, internal combustion engines use liquid lubricating oil compositions. Such fluids are generally held in reservoirs associated with the engine and may require periodic replacement.

During operation, the fluids may be circulated through the engine to impart various benefits. Often, to ensure that sufficient fluid is available to continuously cycle the fluid through the engine, the fluid is continuously returned to an engine sump, from which it can be drawn for further circulation. The engine sump provides a reservoir of the engine fluid, which reduces the likelihood of exhausting the liquid supply during operation. Likewise, the engine sump can provide a container for surplus liquid that is returned after being cycled through the engine.

Maintaining the amount of fluid in the system, and particularly in the engine sump, within the designed operating range can prevent time consuming and costly maintenance or damage. Conventionally the engine sump provides the engine with some tolerance in the amount of fluid circulating through the engine system to ensure the safe and proper function of the engine. This tolerance is normally implemented as a range between a minimum and maximum quantity, such as volume, which must be manually checked and maintained by fluid addition or removal by the operator. This manual process of checking is often time consuming and dirty.

In the case of internal combustion engines, crankcase lubricating oil is subject to consumption by burning when oil migrates into the combustion chamber from the crankcase. Consequently there is a normally occurring continuous reduction in the amount of oil in the sump during engine operation. If the designed operating volume range is relatively small, the frequency of manually checking and adjustment of the sump volume must be increased to avoid scenarios where the oil amount falls below the minimum safe quantity.

### OVERVIEW

Disclosed herein are methods and systems for maintaining the quantity of fluid in a sump. Beneficially, the methods and systems use a fluid container with a fluid reservoir for providing additional fluid or receiving excess fluid when needed.

Thus, in a first aspect, the present disclosure provides a method of maintaining a predetermined working quantity of fluid in a reduced volume sump of a motor or vehicle, the method comprising:
recurrently determining a quantity of fluid in the sump and comparing the determined quantity of fluid to the predetermined working fluid quantity; and
responsive to identifying a deviation between the determined quantity of fluid and the predetermined working fluid quantity, sending a control signal to a fluid pumping system to transfer fluid between the sump and a fluid container.

In an embodiment, the sump is an engine sump.

In another embodiment, the fluid is lubricating oil.

In another embodiment, the predetermined working fluid quantity includes a range of values of fluid quantity.

In another embodiment, the quantity of fluid is a volume of fluid.

In another embodiment, if the determined quantity of fluid is above the predetermined working fluid quantity, the control signal comprises a drain control signal and the fluid pumping system is configured to transfer fluid from the sump to the fluid container in response to the drain control signal, and
if the determined quantity of fluid is below the predetermined working fluid quantity, the control signal comprises a fill control signal and the fluid pumping system is configured to transfer fluid from the fluid container to the sump in response to the fill control signal.

In another embodiment, the fluid pumping system includes a bidirectional pump,
responsive to the drain control signal, the bidirectional pump is configured to operate in a first direction, and
responsive to the fill control signal the bidirectional pump is configured to operate in a second direction.

In another embodiment, the fluid pumping system includes a fill pump and a drain pump,
the drain pump is configured to operate in response to receiving the drain control signal, and
the fill pump is configured to operate in response to receiving the fill control signal.

In another embodiment, in response to the control signal, the fluid pumping system is configured to transfer a predetermined transfer amount of fluid between the sump and the fluid container.

In another embodiment, the method further includes recurrently sending the control signal to the fluid pumping system until the deviation between the determined quantity of fluid and the predetermined working fluid quantity is removed.

In another embodiment, determining the quantity of fluid includes receiving a fluid quantity signal indicative of a fluid quantity from a level sensor.

In another embodiment, determining the quantity of fluid includes receiving measurements from at least two sensors and calculating the determined quantity of fluid based on the measurements from the at least two sensors.

In a second aspect, the disclosure provides a computer program product or non-transient medium comprising instructions configured to execute the method steps of the disclosure.

In a third aspect, the disclosure provides a system comprising:
an engine including a reduced volume engine sump;
a fluid container in fluid communication with the engine sump;
a fluid pumping system disposed between the engine sump and the fluid container and operable to transfer fluid between the engine sump and the fluid container; and
a controller configured to perform operations comprising the steps of the method of the disclosure

In an embodiment, the controller comprises at least one memory and at least one processor, wherein the at least one processor executes instructions stored in the at least one memory so as to carry out the operations.

In another embodiment, wherein the controller comprises at least one of: an application-specific integrated circuit (ASIC) or a field-programmable gate array (FPGA).

In another embodiment, the reduced volume engine sump has a volume that is no more than 10% greater than the volume of fluid used to operate the engine.

In another embodiment, the fluid pumping system includes a bidirectional pump configured to transfer fluid from the engine sump to the fluid container and from the fluid container to the engine sump.

In another embodiment, the fluid pumping system comprises:
a drain pump configured to transfer fluid from the engine sump to the fluid container, and
a fill pump configured to transfer fluid from the fluid container to the engine sump.

In another embodiment, the fluid comprises lubricating oil.

In another embodiment, the method further includes a fluid level sensor configured to measure the quantity of fluid in the engine sump.

These as well as other aspects, advantages, and alternatives, will become apparent to those of ordinary skill in the art by reading the following detailed description.

### BRIEF DESCRIPTION OF THE DRAWINGS

The accompanying drawings are included to provide a further understanding of the methods and devices of the disclosure, and are incorporated in and constitute a part of this specification. The drawings are not necessarily to scale, and sizes of various elements may be distorted for clarity. The drawings illustrate one or more embodiment(s) of the disclosure, and together with the description serve to explain the principles and operation of the disclosure.

FIG. 1 is a flow chart illustrating a method according to an example embodiment;

FIG. 2 is a flow chart illustrating a method according to another example embodiment;

FIG. 3 is a schematic side view of a fluid system of an engine according to an example embodiment;

FIG. 4 is a schematic side view of a fluid system of an engine according to another example embodiment;

FIG. 5 is a schematic side view of a fluid system of an engine according to yet another example embodiment; and

FIG. 6 is a schematic side view of a fluid system of an engine according to still another example embodiment.

### DETAILED DESCRIPTION

Examples of methods and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features. In the following detailed description, reference is made to the accompanying figures, which form a part thereof. In the figures, similar symbols typically identify similar components, unless context dictates otherwise. Other embodiments may be utilized, and other changes may be made, without departing from the scope of the subject matter presented herein.

The example embodiments described herein are not meant to be limiting. It will be readily understood that the aspects of the present disclosure, as generally described herein, and illustrated in the figures, can be arranged, substituted, combined, separated, and designed in a wide variety of different configurations, all of which are explicitly contemplated herein.

As used herein, with respect to measurements, “about” means+/−5%.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

Reference herein to “one embodiment” or “one example” means that one or more feature, structure, or characteristic described in connection with the example is included in at least one implementation. The phrases “one embodiment” or “one example” in various places in the specification may or may not be referring to the same example.

As used herein, a system, apparatus, device, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

In the following description, numerous specific details are set forth to provide a thorough understanding of the disclosed concepts, which may be practiced without some or all of these particulars. In other instances, details of known devices and/or processes have been omitted to avoid unnecessarily obscuring the disclosure. While some concepts will be described in conjunction with specific examples, it will be understood that these examples are not intended to be limiting.

The methods and systems described herein are adapted for maintaining a predetermined working quantity of fluid in a sump of a motor or vehicle. The motor may be an engine or an electrically powered motor that operates with the use of a working fluid. The methods and systems of the disclosure may be used in or with a wide variety of different machines that utilize a motor. For example, the methods and systems may be used with lawnmowers, generators, compressors or hand tools, such as chainsaws, hedge trimmers or leaf blowers that include a motor. Likewise, the methods and systems may be used with various different types of vehicles that include a motor. Such a vehicle can be a car, a boat, a motorcycle, a train or an airplane, for example. Likewise, the methods and systems of the disclosure can be used with vehicles that include other fluid systems, such as transmission fluid systems or battery coolant circulation systems of a hybrid or electric vehicle. As an example embodiment, the motor may be an engine of a vehicle and the sump may be an engine sump that is used to collect fluid circulated through the engine.

In some embodiments, the fluid may be a lubricating oil. In various embodiments, the lubricating oil may include at least one base stock and at least one lubricating oil additive. Suitable base stocks include bio-derived base stocks, mineral oil derived base stocks, synthetic base stocks, and semi synthetic base stocks. Suitable lubricating oil additives, for example engine lubricating oil additives, may be organic and/or inorganic compounds, as will be appreciated by those of ordinary skill in the art. In some embodiments, the lubricating oil includes a range of 60% to 90% by weight base stock and 40% to 10% by weight additives. The lubricating oils may be mono-viscosity grade or multi-viscosity grade engine lubricating oil. Examples of suitable lubricating oil include single purpose lubricating oil and multipurpose lubricating oil.

The term “predetermined working fluid quantity,” as used herein, may refer to a target operating quantity or to the operating range for a particular mode of operation of the machinery associated with the sump. For example, in some embodiments, the range of the predetermined working fluid quantity may represent the working limits of fluid in the sump to remain within a normal mode of operation of the machinery. In other embodiments, the range may represent the working limits to remain within a specialized mode of operation, for example, when the machinery may benefit from a greater or lesser quantity of fluid in the fluid circulation system and sump. In other words, the range of the quantity of the fluid maintained according to the method need not extend to the minimum and maximum fluid quantities that are acceptable for operation of the machinery. On the other hand, in some embodiments the range of the predetermined working fluid quantity does extend to the minimum and/or maximum quantities for acceptable operation of the machinery.

The term “working control limits,” as used herein, refers to the operating range for a particular mode of operation. For example, in some embodiments, the range may represent the working limits to remain within a normal mode of engine operation. In other embodiments, the range may represent the working limits to remain within a specialized mode of operation, for example, when the engine system may benefit from a greater or lesser quantity of fluid in the fluid circulation system and sump. In other words, the range of the quantity of the fluid maintained according to the method need not extend to the minimum and maximum fluid quantities that are acceptable for engine operation. Although in some embodiments the range of working control limits does extend to the minimum and/or maximum quantities for acceptable operation.

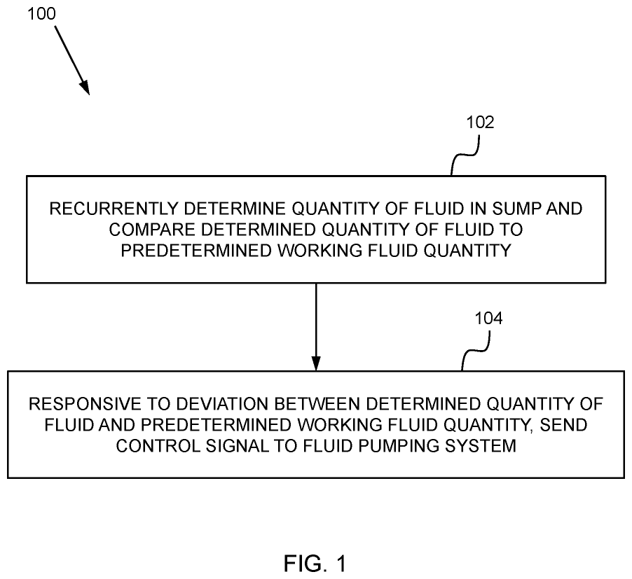

With reference to the Figures, FIG. 1 is a flow chart illustrating a method 100 according to an example embodiment. More specifically, FIG. 1 illustrates a method of maintaining a predetermined working quantity of fluid in a reduced volume sump of a motor or vehicle. As shown by block 102, the method 100 may involve recurrently determining a quantity of fluid in the sump and comparing the determined quantity of fluid to the predetermined working fluid quantity. Further the method 100 may involve, as shown by block 104, in response to identifying a deviation between the determined quantity of fluid and the predetermined working fluid quantity, sending a control signal to a fluid pumping system to transfer fluid between the sump and a fluid container. As explained in more detail below, the fluid container may include a fluid reservoir that is in fluid communication with the sump allowing fluid to be transferred between the fluid reservoir and the sump.

The quantity of the fluid in the engine sump that is determined in method 100 at block 102 can take various forms. In one example, the quantity of fluid that is measured at block 102 is a volume of fluid stored in the engine sump. In another example, the quantity of fluid that is measured at block 102 is a height of the fluid measured against the sump. For example, as will be appreciated by those of skill in the art, a fluid level sensor including a float may be used to determine the height of the surface of the fluid in the engine sump. In another example, a fluid level sensor can determine the height of the fluid in the engine sump by measuring the capacitance of the sensor, which varies through different heights of oil. Optical methods may also be used to measure the height of the fluid in the engine sump. Other physical or electronic sensors may also be used to measure the quantity of fluid, as will be appreciated by those of ordinary skill in the art, including such sensors as ultrasonic sensors. The height of the fluid can be used directly in the methods described herein as a measure of the quantity of fluid, or the height can be converted into a corresponding volume of fluid, for example using an equation or a correlation table, that is then used in the method. Further, in another example, the volume of the fluid can be measured directly, for example, by initially introducing a known quantity of fluid into the sump and monitoring any variance between the fluid pumped out of and returned to the sump during operation.

In an example of method 100, the quantity of fluid that is determined at block 102 is based on a single instantaneous reading of a fluid quantity measurement. This measurement may be acquired by a fluid level sensor, or it may be acquired in another manner. For example, in some embodiments, the quantity of fluid may be determined by examining the amount of fluid that is being circulated through the fluid system. In some embodiments, an instantaneous reading of a sensor may be adjusted using equations to calculate an improved fluid quantity measurement based on supplemental data from other sensors or systems, such as an equation that uses data from an accelerometer to modify the output of a fluid level sensor, or data from the engine or from a processor provided in the replaceable fluid container. Alternatively temporal averaging or other statistical processing may be used to improve the accuracy of such an instantaneous signal.

In another example of method 100, the quantity of fluid that is determined at block 102 is based on averaging several readings of the fluid quantity. The term averaging, as used herein, may or may not refer to a simple statistical mean. Other statistical methods to combine multiple data points to measure the quantity of fluid can also be used, as will be appreciated by those of ordinary skill in the art. In particular, in one example, if the quantity of fluid fluctuates around the predetermined working fluid quantity over a timescale T, then the step of measuring can be carried out over a timescale longer than T. For example, if operation of the associated machinery results in the fluid being returned to the sump in periodic surges, the quantity of fluid in the sump may cycle as a result of these surges. Similarly, varying orientation of the machinery may result in different readings of the quantity of fluid. For example, the measurement of the quantity of fluid in an engine sump of a vehicle is often influenced by the orientation of the vehicle, such as when the vehicle is on a slope. Therefore, when the readings of the fluid are varying over a certain timescale, then the quantity of fluid that is used in the method of the disclosure can be measured over a timescale that is longer than timescale T. For example, if the readings by a fluid level sensor in the sump periodically cycle over a timescale T, the measurement of the quantity of fluid that is used in the method of the disclosure may be carried out over a timescale of 2T or 3T. A wide variety of different statistical methods can be used to determine the quantity of fluid over a lengthened timescale, as will be appreciated by those of ordinary skill in the art.

In an example of method 100, the step of sending a control signal to the fluid pumping system to transfer fluid between the sump and the fluid container at block 104 is adapted based on whether the determined quantity of fluid is above or below the predetermined working fluid quantity. Thus, if the determined quantity of fluid is above the predetermined working fluid quantity, the control signal may include a drain control signal where the fluid pumping system is operable to transfer fluid from the sump to the fluid container in response to the drain control signal. On the other hand, if the determined quantity of fluid is below the predetermined working fluid quantity, the control signal may include a fill control signal where the fluid pumping system is operable to transfer fluid from the fluid container to the sump in response to the fill control signal.

For example, if the determined quantity of fluid is above an upper marker m₂, then a drain control signal is sent to the fluid pumping system in order to transfer fluid from the sump to the fluid container. The marker m₂ may correspond to a preset fluid quantity at the upper end of a range of the predetermined working fluid quantity. The value of m₂ may correspond directly to the actual quantity of fluid, or it may correspond to a specific measurement of the fluid. For example, the marker m₂ can be a specific height in the sump. Thus, if the fluid quantity in the sump rises above the height of m₂, the fluid level sensor will read the quantity of fluid as above the upper marker m₂. In such a case, the method may include removing fluid from the sump to the reservoir of the fluid container. In some example embodiments, the fluid is removed from the sump at block 104 if the quantity of fluid, as measured over a timescale T as explained above, rises above the upper marker m₂. In other example embodiments, the fluid is removed from the sump at block 104 if the quantity of fluid is instantaneously measured as above the upper marker m₂. Likewise, if the determined quantity of fluid is below a lower marker m₁, then a fill control signal is sent to the fluid pumping system in order to transfer fluid to the sump from the fluid container. The marker m₁ may correspond to a preset fluid quantity at the lower end of the range of the predetermined working fluid quantity. Similar to m₂, the value of m₁ may correspond directly to the actual quantity of fluid, or it may correspond to a specific measurement of the fluid. For example, the marker m₁ can be a specific height in the sump. Thus, if the fluid quantity in the sump drops below the height of m₁, the fluid level sensor will read the quantity of fluid as below the marker m₁. In such a case, the method may include adding fluid to the sump from the reservoir of the fluid container. In some example embodiments, the additional fluid is provided to the sump at block 104 if the quantity of fluid, as measured over a timescale T as explained above, drops below the lower marker m₁. In other example embodiments, the fluid is added to the sump at block 104 if the quantity of fluid is instantaneously measured as below the lower marker m₁.

In some embodiments, the predetermined working fluid quantity may include a target fluid quantity t. In an example embodiment, the target fluid quantity t may be the average between m₁ and m₂. In other embodiments, the target fluid quantity t may be closer to one of the markers than the other. For example, engine operating requirements may compel a target fluid quantity t that is closer to one end of the operating range. Alternatively, or in addition, the shape of the sump may suggest a larger interval between one of the markers and the target fluid quantity t than the other, for example, if the volume of the sump increases at a higher rate on one side of the target fluid quantity t than the other.

In an example embodiment, block 104 may include, in response to receiving the control signal, operating the fluid pumping system in order to transfer a predetermined transfer amount of fluid between the sump and the fluid container. For example, the quantity of fluid that is added to or removed from the engine sump may be the deviation between a respective marker, m₁ or m₂, and a target fluid quantity t. For example, if the determined quantity of fluid is above marker m₂, such that the method 100 proceeds to remove fluid from the sump, the amount of fluid removed from the sump may be determined by the deviation x between the target fluid quantity t and the marker m₂, i.e., the difference between m₂ and t. Thus, such a method may operate with a feedforward control system.

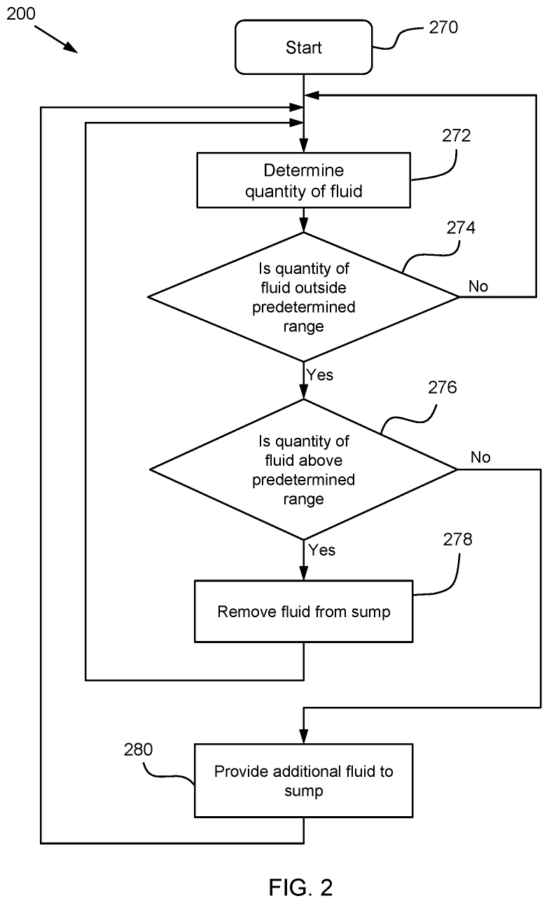

In another embodiment of method 100, blocks 102 and 104 form a feedback control system. For example, FIG. 2 is a flow chart illustrating additional details of such a method. Method 200 continuously cycles through a number of steps 272 to 280 in order to maintain the quantity of fluid at or within the predetermined working fluid quantity. Specifically, method 200 begins at start element 270 and proceeds to element 272 where the quantity of fluid is measured. At decision element 272, the system determines whether the quantity of fluid is outside the range of the predetermined working fluid quantity. If the quantity of fluid is not outside the range, then method 200 will return to element 272 without taking further action and measure the quantity of fluid again. However, if the quantity of fluid is outside the range of the predetermined working fluid quantity, the method will proceed.

At decision element 276, the system determines whether the quantity of fluid is above the predetermined working fluid quantity. If so, the system proceeds through the method to remove fluid from the sump at element 278 and then returns to element 272 to again measure the quantity of fluid. If the quantity of fluid is still above the predetermined working fluid quantity, this cycle repeats, measuring the quantity of fluid and adding additional fluid in a series of increments, until the quantity of fluid is at or within the predetermined working fluid quantity. On the other hand, if at decision element 276, the system determines that the quantity of fluid is not above the predetermined working fluid quantity, the method proceeds to element 280 and the system provides additional fluid to the sump from the fluid reservoir and subsequently returns to element 272 to measure the quantity of fluid again. As above, if the quantity of fluid is still below the predetermined working fluid quantity, the system may repeatedly cycle through the method incrementally adding fluid to the sump until the quantity of fluid is at or within the predetermined working fluid quantity. The amount of fluid that is provided to or removed from the sump during each cycle of the method may be based on the duration of each cycle and/or the flow rate of the fluid to/from the sump. As will be appreciated by those of ordinary skill in the art, the feedback control system can take various forms, such as a proportional-integral-derivative controller (PID controller) that helps prevent overshooting without significant delays.

In another example of method 100 or 200, additional fluid that is added to the sump may include fluid that has passed through the filter. For example, the additional fluid that is routed from the reservoir into the sump may first pass through a filter before it is added to the sump.

In an example of the method of the disclosure, the step of providing additional fluid to the sump includes pumping fluid from the fluid container and the step of removing excess fluid from the sump includes pumping fluid to the reservoir of the replaceable fluid container. For example, the system used to carry out the method may include a pump, as described in more detail below, which pumps the fluid between the fluid reservoir of the replaceable fluid container and the sump.

In some embodiments, the fluid pumping system may include a bidirectional pump. Accordingly, upon receiving a drain control signal the bidirectional pump may be configured to operate in a first direction so as to remove fluid from the sump. On the other hand, upon receiving a fill control signal, the bidirectional pump may be configured to operate in a second direction so as to add fluid to the sump.

In other embodiments, the fluid pumping system may include a drain pump and a fill pump that are both in fluid communication with the fluid container and the sump. Accordingly, upon receiving a drain control signal the drain pump is configured to operate so as to remove fluid from the sump to the fluid container. On the other hand, upon receiving a fill control signal the fill pump is configured to operate so as to add fluid to the sump from the fluid container.

In an example of method 100 or 200, the steps of the method are carried out by a controller. Examples of such a controller are described in more detail below with reference to an example embodiment of a system of the disclosure.

In an example embodiment, the predetermined working fluid quantity is determined based on the size, the size and shape of the sump, and/or desired performance characteristics of the engine. For example, the predetermined working fluid quantity may be determined based on the number of cylinders in the engine, or based on the total displacement of the engine. Further, as another example, the predetermined working fluid quantity may be determined based on the quantity of oil needed to prevent the drawing of air from the sump into the fluid system. Further, as yet another example, the predetermined working fluid quantity may be determined based on the range of rpm in which the engine operates.

In another embodiment, the method further comprises a step of determining the predetermined working fluid quantity to improve engine performance characteristics. For example, the method may include a step of determining the predetermined working fluid quantity based on current engine operating conditions and desired performance. Thus, the predetermined working fluid quantity may vary during engine operation as the engine performance characteristics change. Improving or optimizing the fluid level can lead to a range of benefits. For example, using a precise amount of fluid can lead to improved thermal management and improved engine fuel efficiency, as heating an excess quantity of fluid that is retained in the sump and unused can be avoided.

In another embodiment, the range of the predetermined working fluid quantity may be set to a preset percentage of the overall quantity of fluid in the sump. For example, in some embodiments, the size of the range of the predetermined working fluid quantity is less than 10% relative to the value of the upper end of the range. For example, the range between lower marker m₁ and upper marker m₂ may be 5-10% of the value of the upper marker m₂. Thus, the method can hold the quantity of fluid within a small range, avoiding either a shortage or a storage surplus while operating efficiently.

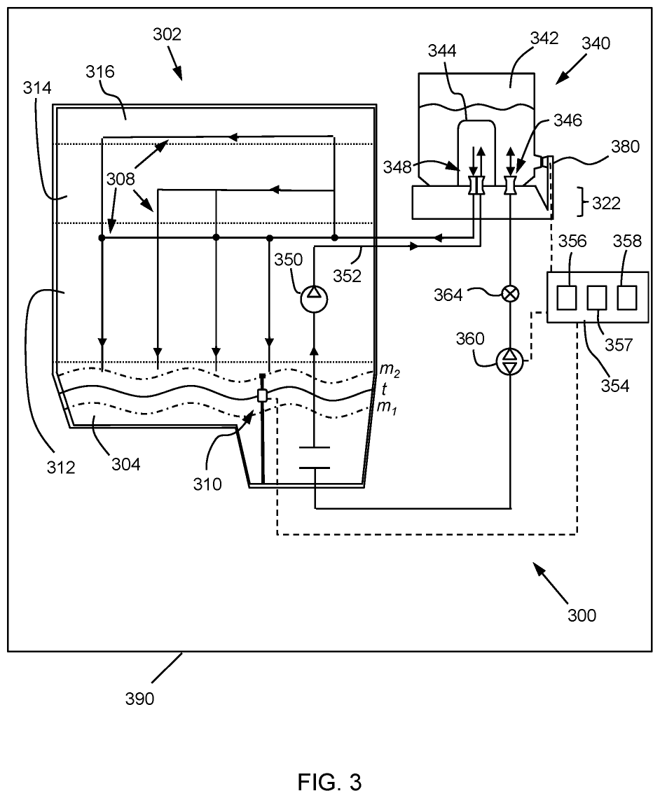

FIGS. 3-6 schematically illustrate fluid systems for an engine according to example embodiments that may employ the method of the disclosure. Fluid paths of the fluid systems, such as conduits, passages, or pipes, are illustrated with solid lines, and fluid containers are identified by the undulating surface of a liquid.

FIG. 3 schematically depicts an example fluid system 300 for circulating fluid through an engine 302 and for directing fluid between the engine 302 and a replaceable fluid container 340. The engine 302 may be part of a motor vehicle 390 for providing drive power to the vehicle, or it may be part of another apparatus that includes an engine, such as a boat, compressor, generator, lawnmower or a hand tool, including a chainsaw, hedge trimmer or leaf blower.

The fluid system 300 includes a number of fluid passages 308 that extend through the engine 302 and are in fluid communication with an engine sump 304 that is adapted to contain a quantity of fluid at a predetermined working fluid quantity, which is illustrated in FIG. 3. The engine sump 304 may also include a fluid level sensor 310 that measures the fluid level in the engine sump 304.

Further, the engine 302 includes an engine block 312, a cylinder head 314 and a cylinder head cover or valve cover 316. The example embodiment of the fluid system 300 depicted in FIG. 3 takes the form of an engine oil circulation system and the fluid passages 308 take the form of oil galleries that run through the different parts of the engine 302 to lubricate moving components of the engine 302. The fluid passages 308 (e.g., oil galleries) supply oil to the engine components that require lubricating and the surplus oil flow returns to the engine sump 304, located at the bottom of the engine. In other embodiments, the fluid circulation system may be a circulation system for a different fluid and the fluid passages may extend through different parts of the engine.

The fluid system 300 may further include a replaceable fluid container 340 that includes a fluid reservoir 342 and a filter 344. The replaceable fluid container 340 may be situated on a dock 322 that may be a part of the motor vehicle 390. The dock 322 may include fluid port couplings that are configured to receive a first fluid port coupling 346 of the fluid container 340 that is associated with the fluid reservoir 342 and a second fluid port coupling 348 associated with the filter 344. In the particular embodiment shown in FIG. 3, the fluid container 340 takes the form of an oil cell, and the filter 344 takes the form of an oil filter. For example, the filter 344 may be a spin-on type oil filter.

The fluid system 300 may also comprise an oil circulation pump 350 that is in fluid communication with the engine sump 304, the filter 344 of the replaceable fluid container 340, and the fluid passages 308 of the engine 302. Further, fluid system 300 may also include a transfer pump 360 that is in fluid communication with the fluid reservoir 342 of the replaceable fluid container 340 and the engine sump 304. The transfer pump may be a two way pump. Alternatively, the transfer pump 360 can pump the fluid in one direction and allow gravity to drain the fluid in the opposite direction. The term pump, as will be understood by those of ordinary skill in the art, includes a device that uses energy to move a fluid. For example, the pump can be formed by any actuator or mechanism that moves fluid, such as a gear pump, trochoid pump, or vane pump.

FIG. 3 includes a schematic representation of a controller 354 included in the fluid system 300. The controller 354 includes a non-transitory computer-readable medium with program instructions stored thereon for performing the method of the disclosure. In some embodiments, the controller 354 may include at least one memory 356, at least one processor 357, and/or a network interface 358. Additionally or alternatively, in other embodiments, the controller 354 may include a different type of computing device operable to carry out the program instructions. For example, in some embodiments, the controller may include an application-specific integrated circuit (ASIC) that performs processor operations, or a field-programmable gate array (FPGA).

While the controller 354 of the fluid system 300 may be included in a single unit and/or provided in a distinct housing, as shown in FIG. 3, in other embodiments, at least some portion of the controller 354 may be separate from the housing. For example, in some embodiments, one or more parts of the controller 354 may be part of a smartphone, tablet, notebook computer, or wearable device. Further, in some embodiments, the controller 354 may be a client device, i.e., a device actively operated by the user, while in other embodiments, the controller 354 may be a server device, e.g., a device that provides computational services to a client device. Moreover, other types of computational platforms are also possible in embodiments of the disclosure.

The memory 356 is a computer-usable memory, such as random access memory (RAM), read-only memory (ROM), non-volatile memory such as flash memory, a solid state drive, a hard-disk drive, an optical memory device, and/or a magnetic storage device.

The processor 357 of the controller 354 may include computer processing elements, e.g., a central processing unit (CPU), a digital signal processor (DSP), or a network processor. In some embodiments, the processor 357 may include register memory that temporarily stores instructions being executed and corresponding data and/or cache memory that temporarily stores performed instructions. In certain embodiments, the memory 356 stores program instructions that are executable by the processor 357 for carrying out the methods and operations of the disclosure, as described herein.

The network interface 358 provides a communications medium, such as, but not limited to, a digital and/or an analog communication medium, between the controller 354 and other computing systems or devices. In some embodiments, the network interface may operate via a wireless connection, such as IEEE 802.11 or BLUETOOTH, while in other embodiments, the network interface 358 may operate via a physical wired connection, such as an Ethernet connection. Still in other embodiments, the network interface 358 may communicate using another convention.

The controller 354 may also be in communication with a data reader 380 of the dock 322. The data reader 380 may be configured to read data stored by the fluid container 340. In some embodiments, the fluid container 340 may be configured to store identification data indicating, for example, a serial number, manufacturer details, service history data, service regime data, one or more property of one or more of the fluids contained therein, the vehicle with which the fluid container is designed to be used, container history data, engine history data of an engine with which the fluid container has been used, and may be configured to communicate the identification data to the controller 354 via the data reader 380. Further, the controller 354 may be configured to select, or update, a service interval or control regime based on fluid-quality data provided by one or more sensors located in the engine or the fluid container or on data provided from elsewhere.

In the embodiment depicted in FIG. 3, the controller 354 is within the vehicle, and is separated from the replaceable fluid container 340. In this particular example, the controller is an engine controller 354 that controls the engine operation as well as the fluid system 300. In other examples, the controller 354 is separate from the engine controller and is housed inside replaceable fluid container 340 or elsewhere within the vehicle. In particular, in such examples, the controller may be operable to receive signals from the fluid level sensor 310, control the transfer pump 360, and coordinate data transfer with the engine through data reader 380.

In operation, oil circulation pump 350 may circulate oil through a fluid supply path 352 to the oil filter 344 that is housed in replaceable fluid container 340. As the oil passes through filter 344, contaminants are removed. The oil is then fed through the fluid passages 308 that extend through the engine until it is returned to the engine sump 304. The oil circulation pump 350 may be mechanically driven by the engine. In some embodiments, the operation of the oil circulation pump 350 may be controlled by controller 354 or another control system, such as the engine control system.

The fluid system 300 may also be configured to maintain the quantity of fluid in engine sump 304 within a predetermined range that is within the predetermined working fluid quantity. During operation of the engine, the quantity of fluid in the engine sump 304 is repeatedly monitored. As explained above, the quantity of fluid can be measured instantaneously, or over a predefined timescale T. If the determined quantity of fluid is below the predetermined working fluid quantity, as measured by the fluid level sensor 310, then the transfer pump 360 is operated to provide additional fluid from the reservoir 342 of replaceable fluid container 340 into the engine sump 304. On the other hand, if the determined quantity of fluid is above the predetermined working fluid quantity, then the transfer pump 360 is operated in reverse, in order to remove excess fluid from engine sump 304 and into the fluid reservoir 342 of replaceable fluid container 340. Specifically, in some embodiments, the transfer pump 360 is operated to add additional fluid to the engine sump 304 from the reservoir 342 when the fluid level sensor 310 measures a quantity of fluid that is below a lower marker m₁. Likewise, the transfer pump is operated to remove excess fluid from engine sump 304 when the fluid level sensor 310 measures a quantity of fluid that is at or above the upper marker m₂. The fluid line between the engine sump 304 and the fluid reservoir 342 may include a valve 364 to prevent the free flow of fluid between the engine sump 304 and the reservoir 342 when the transfer pump 360 is not in operation. In other embodiments, the transfer pump 360 may prevent flow through the associated line when it is not in operation.

In one embodiment, the replaceable fluid container 340 is an oil cell that is adapted for providing fresh oil to the engine during an oil change and removing the spent oil from the engine after it has been used. Accordingly, the fluid reservoir 342 may hold lubricating oil, for example, engine lubricating oil. In particular, the replaceable fluid container 340 (e.g., an oil cell) can provide fresh, refreshed or unused lubricating oil which may conveniently replace a fluid container holding used or spent lubricating oil. During such an oil change operation, the reservoir in the fluid container 340 may retain a reserve quantity of fluid for use in the methods described herein.

In addition to the elements shown in fluid system 300 and the other fluid systems described herein, embodiments of the method and system of the disclosure may include additional fluid paths and valves for various reasons, as will be appreciated by those of ordinary skill in the art. For example, check valves may be included in the flow paths to regulate the direction of flow, pressure release valves may be included to prevent a pressure buildup, bypass paths may be included to provide alternative pathways, and controllable valves may be included in the flow paths to redirect flow of the fluid for various reasons.

The fluid port couplings of the fluid system, for example the couplings between the dock 322 and the fluid container 340 provide a fluid connection when the couplings are attached. In some embodiments, the fluid port coupling connection may be configured to allow fluid flow in a single direction. For example, the connected fluid port couplings may provide a fluid connection for a single fluid path and one or both of the couplings may include a check valve allowing flow in only a single direction. In other embodiments, the fluid port coupling connection may provide fluid flow in two directions. For example, the fluid port coupling connection may form a single fluid path with unrestricted flow in both directions. Alternatively, in some embodiments, the fluid port coupling connection may form more than one fluid path, such that liquid may flow in one direction through one fluid path of the connection and in the opposite direction through a second fluid path of the fluid port coupling connection. In this case, both paths may include check valves without preventing flow in either direction.

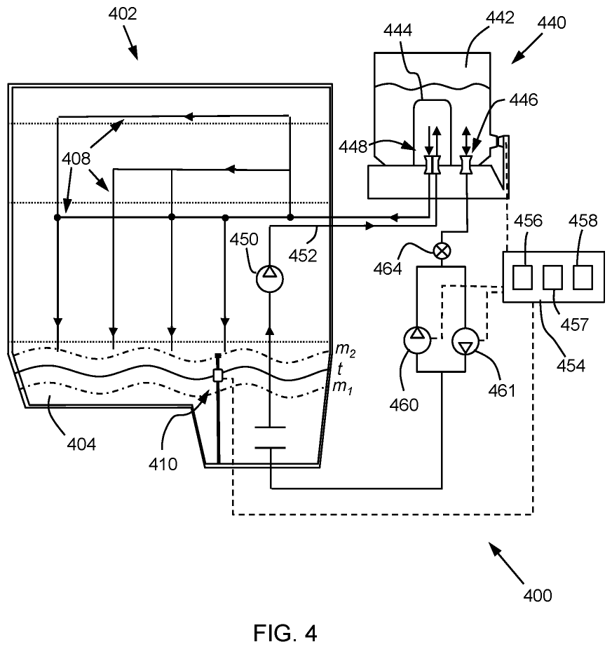

FIG. 4 schematically depicts another example fluid system 400 for circulating fluid through an engine 402 and for directing fluid between the engine 402 and a replaceable fluid container 440. As with fluid system 300, fluid system 400 may be used in a variety of different machinery that employs an engine.

Engine 402 includes an engine sump 404 that is adapted to contain a quantity of fluid at a predetermined working fluid quantity. The fluid system 400 includes fluid passages between the engine 402 and the replaceable fluid container 440, as well as fluid passages 408 that extend through the engine 402 leading to the engine sump 404. The engine sump 404 may also include a fluid level sensor 410 that measures the fluid level in the engine sump 404.

The engine 402 may include various components, similar to engine 302, described above, which are not specifically identified in FIG. 4.

The replaceable fluid container 440 of fluid system 400 may include a fluid reservoir 442 and a filter 444. The replaceable fluid container 440 is situated on a dock that may be a part of the machinery in which the engine 402 is included. The fluid container may include a first fluid port coupling 446 that is associated with the fluid reservoir 442 and a second fluid port coupling 448 associated with the filter 444.

The fluid system 400 may also comprise a drain pump 460 and a supply pump 461 for transferring fluid between the fluid container 440 and the sump 404, as described in more detail below. The fluid lines between the engine sump 404 and the fluid reservoir 442 may include a valve 464 to prevent the free flow of fluid between the sump 404 and the fluid reservoir 442 when the drain pump 460 and the supply pump 461 are not in operation. In other embodiments, the drain pump 460 and the supply pump 461 may prevent flow through the associated lines when not in operation.

The fluid system 400 may also include a controller 454 that operates the valve 464. The controller 454 may have a similar configuration as controller 354, as described above, and include a memory 456 for storing instructions of a method of operation, as described above, a processor 457 for carrying out those instructions, and a network interface 458.

The controller 454 may also be in communication with a data reader, similar to the controller 354 described above with respect to fluid system 300.

In ordinary engine operation, oil circulation pump 450 may circulate oil through a fluid supply path 452 to the oil filter 444 that is housed in replaceable fluid container 440. As the oil passes through filter 444, contaminants are removed. The oil is then fed through the fluid passages 408 that extend through the engine until it is returned to the engine sump 404. The oil circulation pump 450 may be mechanically driven by the engine. In some embodiments, the operation of the oil circulation pump 450 may be controlled by controller 454 or another control system, such as the engine control system.

The fluid system 400 may also be configured to maintain the quantity of fluid in the engine sump 404 within a range that is within the predetermined working fluid quantity. During operation of the engine, a fluid level sensor 410 may be repeatedly monitored to determine the quantity of the fluid in the engine sump 404. If the determined quantity of fluid is below the predetermined working fluid quantity, as measured by the fluid level sensor 410, then the controller 454 may send a control signal to the supply pump 461 in order to add fluid to the sump 404.

On the other hand, if the determined quantity of fluid is above the predetermined working fluid quantity, then the controller may send a control signal to the drain pump 460 in order to remove fluid from the sump 404. As explained in the methods set forth above, the determination to send control signals to the supply pump 461 or the drain pump 460 can be based on a feedback control system or based on markers m₁ and m₂, such as with a feedforward control system.

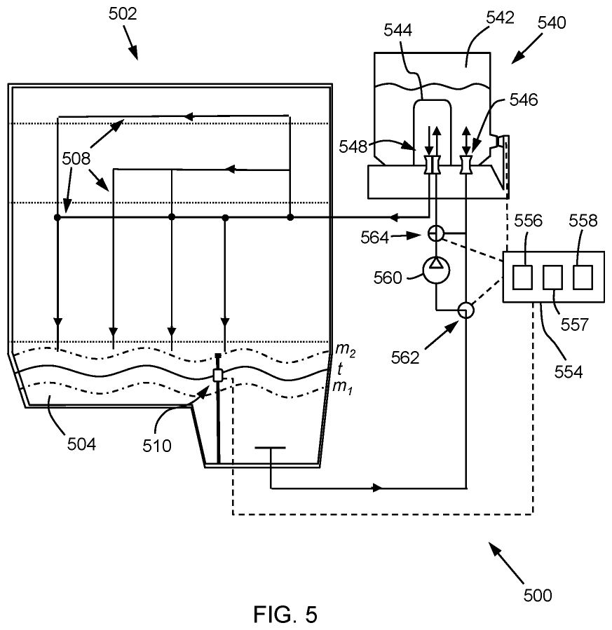

FIG. 5 schematically depicts another example fluid system 500 for circulating fluid through an engine 502 and for directing fluid between the engine 502 and a replaceable fluid container 540. As with fluid system 300, fluid system 500 may be used in a variety of different machinery that employs an engine.

Engine 502 includes an engine sump 504 that is adapted to contain a quantity of fluid at a predetermined working fluid quantity. The fluid system 500 includes fluid passages between the engine 502 and the replaceable fluid container 540, as well as fluid passages 508 that extend through the engine 502 leading to the engine sump 504. The engine sump 504 may also include a fluid level sensor 510 that measures the fluid level in the engine sump 504.

The engine 502 may include various components, similar to engine 302, described above, which are not specifically identified in FIG. 5.

The replaceable fluid container 540 of fluid system 500 may include a fluid reservoir 542 and a filter 544. The replaceable fluid container 540 is situated on a dock that may be a part of the machinery in which the engine 502 is included. The fluid container may include a first fluid port coupling 546 that is associated with the fluid reservoir 542 and a second fluid port coupling 548 associated with the filter 544.

The fluid system 500 may also comprise an oil pump 560 that is selectively in fluid communication with the engine sump 504, the replaceable fluid container 540, the filter 544 of the replaceable fluid container 540, and the fluid passages 508 of the engine 502. Fluid communication between the oil pump 560 and the above components of the fluid system 500 can be controlled by operating either or both of a first valve 562 and a second valve 564 that are positioned in the fluid line between the engine sump 504 and the replaceable fluid container 540. Specifically, first valve 562 is upstream of oil pump 560 and second valve 564 is downstream of oil pump 560.

The fluid system 500 may also include a controller 554 that operates the first and second valves 562, 564. The controller 554 may have a similar configuration as controller 354, as described above, and include a memory 556 for storing instructions of a method of operation, as described above, a processor 557 for carrying out those instructions, and a network interface 558.

The controller 554 may also be in communication with a data reader, similar to the controller 354 described above with respect to fluid system 300.

In ordinary engine operation, the first valve 562 may be in a first position where the upstream side of oil pump 560 is in fluid communication with the engine sump 504 and second valve 564 is in a first position where the downstream side of oil pump 560 is in fluid communication with the filter 544 of replaceable fluid container 540. This configuration enables the oil pump 560 to circulate oil through the filter 544 in order to remove contaminants and otherwise clean the oil. Downstream of filter 544, the oil is fed through the fluid passages 508 that extend through the engine until it is returned to the engine sump 504. The operation of oil pump 560 may be mechanically driven to circulate the oil continuously while the engine is operating or the oil pump 560 may be controlled and powered by the controller 554, so that the parts of the engine are sufficiently lubricated during normal operation. In some embodiments, the controller 554 may intermittently switch the first and second valves 562, 564 to reroute the oil flow, as explained below, at appropriate times. Still in other embodiments the controller 554 can be configured to reroute the oil flow, either partially or fully, during engine running or when the engine is temporarily shut off, for example at a stoplight, or in the case of a hybrid vehicle when the vehicle is utilizing electric power.

The fluid system 500 may also be configured to maintain the quantity of fluid in the engine sump 504 within a range that is within the predetermined working fluid quantity. During operation of the engine, a fluid level sensor 510 may be repeatedly monitored to determine the quantity of the fluid in the engine sump 504. If the determined quantity of fluid is below the predetermined working fluid quantity, as measured by the fluid level sensor 510, then the first valve 562 may be switched to a second position to provide fluid communication between the upstream end of the oil pump 560 and the fluid reservoir 542 of replaceable fluid container 540. Further, the second valve 564 may be kept in the first position, maintaining a fluid connection between the downstream end of the oil pump 560 and the filter 544. Accordingly, rather than removing oil from engine sump 504, further operation of oil pump 560 circulates oil from the reservoir 542 through the filter 544, and back to the engine 502 and the engine sump 504.

On the other hand, if the determined quantity of fluid is above the predetermined working fluid quantity, then the first valve 562 may be kept in the first position providing fluid communication between the engine sump 504 and the upstream end of the oil pump 560. Further, the second valve 564 can be switched to provide fluid communication between the downstream end of the oil pump 560 and the fluid reservoir 542. Accordingly, operation of the oil pump 560 may drive excess oil from the engine sump 504 directly to the reservoir 542 of the replaceable fluid container 540. As explained in the methods set forth above, the determination to switch the first and/or second valves 562, 564 and reroute the fluid can be based on a feedback control system or based on markers m₁ and m₂, such as with a feedforward control system.

In a similar embodiment to system 500, the first valve 562 may be removed and a two-way pump may be used in place of the pump 560. Accordingly, the valve 564 can control fluid communication between the two-way pump and either the fluid reservoir 542 or the filter 544. When the valve 564 connects the two-way pump to the fluid reservoir 542, the pump can operate in either direction in order to either remove fluid from the sump 504 into the reservoir 542 or add fluid to the sump 504 from the reservoir 542.

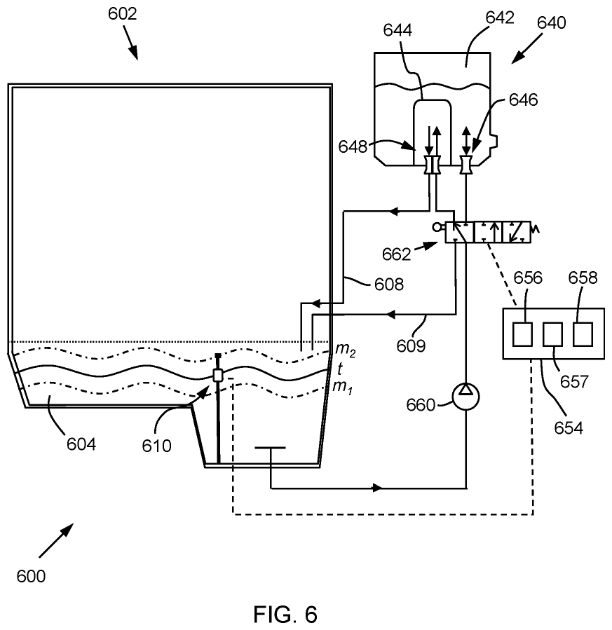

FIG. 6 schematically depicts another example fluid system 600 for circulating fluid through an engine 602 and for directing fluid between the engine 602 and a replaceable fluid container 640. As with fluid system 300, fluid system 600 may be used in a variety of different machinery that employs an engine.

Engine 602 includes an engine sump 604 that is adapted to contain a quantity of fluid at a predetermined working fluid quantity. The engine sump 604 may also include a fluid level sensor 610 that measures the fluid level in the engine sump 604. The fluid system 600 may include fluid passages between the engine 602 and the replaceable fluid container 640. The engine 602 may also include various components, similar to engine 302, described above, which are not specifically identified in FIG. 6.

The replaceable fluid container 640 of fluid system 600 may include a fluid reservoir 642 and a filter 644. The replaceable fluid container 640 may be situated on a dock that may be a part of the machinery in which the engine 602 is included. The fluid container 640 may include a first fluid port coupling 646 that is associated with the fluid reservoir 642 and a second fluid port coupling 648 associated with the filter 644.

The fluid system 600 may also comprise an oil pump 660 that selectively provides fluid communication between the engine sump 604 and the filter 644 of the replaceable fluid container 640. Fluid communication between the oil pump 660 and the filter 644 may be controlled by operating a control valve 662 positioned in the fluid line between the engine sump 604 and the replaceable fluid container 640.

The fluid system 600 may also include a controller 654 that operates the control valve 662. The controller 654 may have a similar configuration as controller 354, as described above, and include a memory 656 for storing instructions of a method of operation, a processor 657 for carrying out those instructions, and a network interface 658.

The controller 654 may also be in communication with a data reader, similar to the controller 354 described above with respect to fluid system 300.

The control valve 662 may be positioned between the oil pump 660 and the replaceable fluid container 640. Further, the oil pump 660 may be directly connected to the engine sump 604, such that the oil pump remains in communication with the engine sump 604. In ordinary engine operation, the control valve 662 may be in a first position where the oil pump 660 is in fluid communication with the filter 644 of replaceable fluid container 640. This configuration enables the oil pump 660 to circulate oil from the engine sump 604 to the filter 644 in order to remove contaminants and otherwise clean the oil. After leaving the filter 644, the oil is fed through the return line 608 and back to the engine sump 604. In other embodiments, after leaving the filter 644, the oil may be fed through the engine before returning to the engine sump 604. Such a configuration allows the system to be operated with a single pump that circulates oil through the engine as well as transferring oil to and from the replaceable fluid container 640.

The operation of the oil pump 660 may be mechanically driven to circulate the oil continuously while the engine is operating or controlled and powered by the controller 654, so that the parts of the engine are sufficiently lubricated during normal operation. As explained above, in other embodiments, the controller 654 may switch the valve to reroute the oil flow at various times.

The fluid system 600 may also be configured to maintain the quantity of fluid in the engine sump 604 within a predetermined range that is within the predetermined working fluid quantity. During operation of the engine, a fluid level sensor 610 may be repeatedly monitored to determine the quantity of fluid in the engine sump 604. If there is a deviation between the measured quantity of fluid and the predetermined working fluid quantity, as measured by the fluid level sensor 610, then the control valve 662 may be switched to second and third positions to provide fluid communication between the engine sump 604 and the fluid reservoir 442 of replaceable fluid container 640. Specifically if the quantity of fluid in the engine sump 604 is above the predetermined working fluid quantity, then the control valve 662 may be switched to a second position to provide fluid communication between the oil pump 660 and the fluid reservoir 642 such that the oil pump 660 may pump fluid from the engine sump 604 to the reservoir 642. On the other hand, if the quantity of fluid is below the predetermined working fluid quantity, then the control valve 662 may be switched to a third position providing fluid communication between the reservoir 642 and a drain line 609, so that gravity draws additional fluid from the reservoir into the engine sump. In other embodiments, the control valve 662 may have two positions and the oil pump 660 may be a two-way pump, configured to both add fluid to and remove fluid from the engine sump.

In the fluid system 600, as illustrated in FIG. 6, the return line 608 directs filtered oil back to engine sump 604, rather than through galleries in the engine. Accordingly, the fluid system 600 may also include a separate oil pump and oil circulation system that cycles oil through the engine. Likewise, other embodiments may use this arrangement and include the components and configurations described above with reference to fluid systems 300 and 400.

The above detailed description describes various features and functions of the disclosed systems, devices, and methods with reference to the accompanying Figures. In the Figures, similar symbols typically identify similar components, unless context dictates otherwise. The illustrative embodiments described in the detailed description, Figures, and claims are not meant to be limiting. Other embodiments can be utilized, and other changes can be made, without departing from the scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

### Embodiments

Embodiment 1. A method of maintaining a predetermined working quantity of fluid in a reduced volume sump of a motor or vehicle, the method comprising:
recurrently determining a quantity of fluid in the sump and comparing the determined quantity of fluid to the predetermined working fluid quantity; and
responsive to identifying a deviation between the determined quantity of fluid and the predetermined working fluid quantity, sending a control signal to a fluid pumping system to transfer fluid between the sump and a fluid container.

Embodiment 2. The method according to embodiment 1, wherein the sump is an engine sump.

Embodiment 3. The method according to embodiment 2, wherein the fluid is lubricating oil.

Embodiment 4. The method according to embodiment 1, wherein the predetermined working fluid quantity includes a range of values of fluid quantity.

Embodiment 5. The method according to embodiment 1, wherein the quantity of fluid is a volume of fluid.

Embodiment 6. The method according to embodiment 1, wherein if the determined quantity of fluid is above the predetermined working fluid quantity, the control signal comprises a drain control signal and the fluid pumping system is configured to transfer fluid from the sump to the fluid container in response to the drain control signal, and
wherein if the determined quantity of fluid is below the predetermined working fluid quantity, the control signal comprises a fill control signal and the fluid pumping system is configured to transfer fluid from the fluid container to the sump in response to the fill control signal.

Embodiment 7. The method according to embodiment 6, wherein the fluid pumping system includes a bidirectional pump,
wherein, responsive to the drain control signal, the bidirectional pump is configured to operate in a first direction, and
wherein, responsive to the fill control signal, the bidirectional pump is configured to operate in a second direction.

Embodiment 8. The method according to embodiment 6, wherein the fluid pumping system includes a drain pump and a fill pump,
wherein the drain pump is configured to operate in response to the drain control signal, and
wherein the fill pump is configured to operate in response to the fill control signal.

Embodiment 9. The method according to embodiment 1, wherein, responsive to the control signal, the fluid pumping system is configured to transfer a predetermined transfer amount of fluid between the sump and the fluid container.

Embodiment 10. The method according to embodiment 1, further comprising recurrently sending the control signal to the fluid pumping system until the deviation between the determined quantity of fluid and the predetermined working fluid quantity is removed.

Embodiment 11. The method according to embodiment 1, wherein determining the quantity of fluid includes receiving a fluid quantity signal indicative of a fluid quantity from a level sensor.

Embodiment 12. The method according to embodiment 1, wherein determining the quantity of fluid includes receiving measurements from at least two sensors and calculating the determined quantity of fluid based on the measurements from the at least two sensors.

Embodiment 13. A non-transitory computer readable medium, having stored thereon, instructions that when executed by a computing device, cause the computing device to perform operations comprising the steps of the method according to any of embodiments 1 to 12.

Embodiment 14. A system comprising:
an engine including a reduced volume engine sump;
a fluid container in fluid communication with the engine sump;
a fluid pumping system disposed between the engine sump and the fluid container and operable to transfer fluid between the engine sump and the fluid container; and
a controller configured to perform operations comprising the steps of the method according to any of embodiments 1 to 12.

Embodiment 15. The system according to embodiment 14, wherein the controller comprises at least one memory and at least one processor, wherein the at least one processor executes instructions stored in the at least one memory so as to carry out the operations.

Embodiment 16. The system according to embodiment 14, wherein the controller comprises at least one of: an application-specific integrated circuit (ASIC) or a field-programmable gate array (FPGA).

Embodiment 17. The system according to embodiment 14, wherein the reduced volume engine sump has a volume that is no more than 10% greater than the volume of fluid used to operate the engine.

Embodiment 18. The system according to embodiment 14, wherein the fluid pumping system includes a bidirectional pump configured to transfer fluid from the engine sump to the fluid container and from the fluid container to the engine sump.

Embodiment 19. The system according to embodiment 14, wherein the fluid pumping system comprises:
a drain pump configured to transfer fluid from the engine sump to the fluid container, and
a fill pump configured to transfer fluid from the fluid container to the engine sump.

Embodiment 20. The system according to embodiment 14, wherein the fluid comprises lubricating oil.

Embodiment 21. The system according to embodiment 14, further comprising a fluid level sensor configured to measure the quantity of fluid in the engine sump.

Embodiment 22. A method of maintaining the quantity of fluid q in an engine sump within a predetermined range representing the working control limits of a target fluid quantity t while the engine is in operation, the method comprising:
(a) measuring the quantity q of the fluid in the engine sump;
(b) if the quantity of fluid q is below the target fluid quantity t, providing additional fluid from a replaceable fluid container into the engine sump such that the quantity of fluid q reaches the target fluid quantity t within the working control limits, wherein the replaceable fluid container includes a reservoir of fluid and is in fluid connection with the engine sump;
(c) if the quantity of fluid q is above the target fluid quantity t, removing excess fluid from the engine sump into the replaceable fluid container such that the quantity of fluid q reaches the target fluid quantity t within the working control limits; and
(d) repeating steps (a) through (c) during the operation of the engine to maintain the quantity of fluid q in the engine sump within the predetermined range set by the working control limits.

Embodiment 23. The method according to embodiment 22, wherein the quantity of fluid q is a volume of fluid or a height of fluid measured against the engine sump.

Embodiment 24. The method according to embodiment 22 or 23, wherein when the engine is in operation, if the quantity of fluid q fluctuates around the target fluid quantity t over a timescale T, then the step of measuring is carried out over a timescale longer than T.

Embodiment 25. The method according to embodiments 22 to 24, wherein if the quantity of fluid q is below a lower marker, m₁, where m₁ represents a lower end of the predetermined range, additional fluid is added such that the quantity of fluid q reaches the target fluid volume t.

Embodiment 26. The method according to embodiments 22 to 25, wherein if the quantity of fluid q is above an upper marker, m₂, where m₂ represents an upper end of the predetermined range, additional fluid is removed such that the quantity of fluid q reaches the target fluid volume t.

Embodiment 27. The method according to any of embodiments 22 to 26, wherein steps (a) through (c) form a feedback control system.

Embodiment 28. The method according to any of embodiments 22 to 27 further comprising:

passing excess fluid received at the replaceable fluid container from the engine sump through a filter into the fluid reservoir.

Embodiment 29. The method according to any of embodiments 22 to 28 further comprising using fluid passed through the filter to provide at least a portion of the additional fluid into the engine sump.

Embodiment 30. The method according to any of embodiments 22 to 29, wherein the step of providing comprises pumping fluid from the replaceable fluid container and the step of removing comprises pumping fluid to the replaceable fluid container.

Embodiment 31. The method according to embodiment 24 or 26, wherein the quantity of fluid that is added to or removed from the engine sump is given by the deviation x between the lower marker m₁ and the target fluid quantity t or the target fluid quantity t and the upper marker m₂.

Embodiment 32. The method according to any of embodiments 22 to 31, wherein the steps are controlled by a processor provided in the replaceable fluid container.

Embodiment 33. The method according to any of embodiments 22 to 32, wherein the steps are controlled by a processor provided remote to the replaceable fluid container.

Embodiment 34. The method according to any of embodiments 22 to 33, wherein the steps are controlled by a processor provided in an engine control unit of the engine.

Embodiment 35. The method according to any of embodiments 22 to 34, wherein the target fluid quantity t is determined based on the size and desired performance characteristics of the engine.

Embodiment 36. The method according to any of embodiments 22 to 35, further comprising determining the target fluid quantity t to optimize engine performance characteristics.

Embodiment 37. The method according to embodiment 26 or embodiment 31, wherein the operating range for the quantity of fluid q is set within a range between lower marker m₁ and upper marker m₂ that is less than 10%±0.5% relative to the target fluid quantity t.

Embodiment 38. A computer program product or non-transitory medium comprising instructions configured to execute the method steps of any of embodiments 22 to 37.

Embodiment 39. A fluid system, comprising:
an engine having a sump adapted to contain a quantity of fluid q having a target fluid quantity t;
a fluid level sensor positioned to measure the level of the quantity of fluid q in the engine sump;
a replaceable fluid container containing a reservoir of fluid in fluid connection with the engine sump; and
a processor receiving level signals to determine if the quantity of fluid q is below or above the target fluid quantity t, and to command the flow of fluid into and out of the replaceable fluid container in order to maintain the target fluid quantity t.

Embodiment 40. The fluid system according to embodiment 39, wherein the processor is adapted to determine whether the quantity of fluid q is below a lower marker m₁ or above an upper marker m₂.

Embodiment 41. The fluid system according to embodiment 39, wherein when the engine is in operation, if the quantity of fluid q fluctuates around the target fluid quantity t over a timescale T, then the processor is adapted to measure the quantity of fluid q over a timescale longer than T.

Embodiment 42. The fluid system according to embodiment 39, 40, or 41, wherein the replaceable fluid container further comprises a filter within the reservoir of fluid adapted to receive fluid from the engine sump.

Embodiment 43. The fluid system according to any of embodiments 39 to 42, further comprising a pump in fluid connection between the replaceable fluid container and the engine sump.

1. A method of maintaining a predetermined working quantity of fluid in a reduced volume sump of a motor or vehicle, the method comprising:
recurrently determining a quantity of fluid in the sump and comparing the determined quantity of fluid to a predetermined working fluid quantity in the sump; and
responsive to identifying a deviation between the determined quantity of fluid and the predetermined working fluid quantity, sending a control signal to a fluid pumping system to transfer fluid between the sump and a fluid container.

2. The method as claimed in claim 1, wherein the sump is an engine sump.

3. The method as claimed in claim 2, wherein the fluid is lubricating oil.

4. The method as claimed in claim 1, wherein the predetermined working fluid quantity includes a range of values of fluid quantity.

5. The method as claimed in claim 1, wherein the quantity of fluid is a volume of fluid.

6. The method as claimed in claim 1, wherein if the determined quantity of fluid is above the predetermined working fluid quantity, the control signal comprises a drain control signal and the fluid pumping system is configured to transfer fluid from the sump to the fluid container in response to the drain control signal, and
wherein if the determined quantity of fluid is below the predetermined working fluid quantity, the control signal comprises a fill control signal and the fluid pumping system is configured to transfer fluid from the fluid container to the sump in response to the fill control signal.

7. The method as claimed in claim 6, wherein the fluid pumping system includes a bidirectional pump,
wherein, responsive to the drain control signal, the bidirectional pump is configured to operate in a first direction, and
wherein, responsive to the fill control signal, the bidirectional pump is configured to operate in a second direction.

8. The method as claimed in claim 6, wherein the fluid pumping system includes a drain pump and a fill pump,
wherein the drain pump is configured to operate in response to the drain control signal, and
wherein the fill pump is configured to operate in response to the fill control signal.

9. The method as claimed in claim 1, wherein, responsive to the control signal, the fluid pumping system is configured to transfer a predetermined transfer amount of fluid between the sump and the fluid container.

10. The method as claimed in claim 1, further comprising recurrently sending the control signal to the fluid pumping system until the deviation between the determined quantity of fluid and the predetermined working fluid quantity is removed.

11. The method as claimed in claim 1, wherein determining the quantity of fluid includes receiving a fluid quantity signal indicative of a fluid quantity from a level sensor.

12. The method as claimed in claim 1, wherein determining the quantity of fluid includes receiving measurements from at least two sensors and calculating the determined quantity of fluid based on the measurements from the at least two sensors.

13. A non-transitory computer readable medium, having stored thereon, instructions that when executed by a computing device, cause the computing device to perform operations comprising:
recurrently determining a quantity of fluid in a reduced volume sump of a motor or vehicle and comparing the determined quantity of fluid to a predetermined working fluid quantity in the sump; and
responsive to identifying a deviation between the determined quantity of fluid and the predetermined working fluid quantity, sending a control signal to a fluid pumping system to transfer fluid between the sump and a fluid container.

14. A system comprising:
an engine including a reduced volume engine sump;
a fluid container in fluid communication with the engine sump;
a fluid pumping system disposed between the engine sump and the fluid container and operable to transfer fluid between the engine sump and the fluid container; and
a controller configured to perform operations comprising:
recurrently determining a quantity of fluid in the engine sump and comparing the determined quantity of fluid to a predetermined working fluid quantity in the engine sump, and
responsive to identifying a deviation between the determined quantity of fluid and the predetermined working fluid quantity, sending a control signal to the fluid pumping system to transfer fluid between the engine sump and the fluid container.

15. The system as claimed in claim 14, wherein the controller comprises at least one memory and at least one processor, wherein the at least one processor executes instructions stored in the at least one memory so as to carry out the operations.

16. The system as claimed in claim 14, wherein the controller comprises at least one of: an application-specific integrated circuit (ASIC) or a field-programmable gate array (FPGA).

17. The system as claimed in claim 14, wherein the engine sump has a volume that is no more than 10% greater than the volume of fluid used to operate the engine.

18. The system as claimed in claim 14, wherein the fluid pumping system includes a bidirectional pump configured to transfer fluid from the engine sump to the fluid container and from the fluid container to the engine sump.

19. The system as claimed in claim 14, wherein the fluid pumping system comprises:
a drain pump configured to transfer fluid from the engine sump to the fluid container, and
a fill pump configured to transfer fluid from the fluid container to the engine sump.

20. The system as claimed in claim 14, wherein the fluid comprises lubricating oil.

21. The system as claimed in claim 14, further comprising a fluid level sensor configured to measure the quantity of fluid in the engine sump.
